(19) United States
(12) Patent Application Publication
(10) Pub. No.: US 2026/0013443 A1
(43) Pub. Date: Jan. 15, 2026

(54) PROGRAMMABLE LIGHTING SYSTEM WITH ADAPTIVE SPECTRUM CONTROL FOR OPTIMIZED PLANT GROWTH

(71) Applicant: Chlorophysics, LLC, Jacksonville, FL (US)

(72) Inventor: Jonathan D. Isburgh, Jacksonville, FL (US)

(21) Appl. No.: 19/255,826

(22) Filed: Jun. 30, 2025

Related U.S. Application Data
(60) Provisional application No. 63/668,988, filed on Jul. 9, 2024.

(51) Int. Cl. A01G 7/04; F21V 14/02; F21V 14/06; F21V 29/54; F21V 29/57; F21Y 105/10; F21Y 115/10; H05B 45/10; H05B 45/20; H05B 45/56; H05B 47/115; H05B 47/17; H05B 47/175; H05B 47/28

(52) U.S. Cl. CPC A01G 7/045; F21V 14/02; F21V 14/06; F21V 29/54; F21V 29/57; H05B 45/10; H05B 45/20; H05B 45/56; H05B 47/115; H05B 47/172; H05B 47/196; H05B 47/28; F21Y 2105/10; F21Y 2115/10

(57) ABSTRACT

An apparatus for plant growth illumination may include light emitting diodes (LEDs) configured to emit light in a spectrum between 300 nm and 800 nm. Lenses may be individually associated with respective ones of the LEDs, and each lens may be adjustable relative to its associated LED to modify a focus of the emitted light. A cooling system may be integrated with the plurality of LEDs. The apparatus may be configured to maintain an operating temperature of the LEDs at a predetermined value. A control system may adjust a distance between each optical lens and its associated LED based on sensor input indicating a distance from the LED to a plant canopy. The control system may adjust emitted light intensity and footprint by moving the optical lens closer to or further from its associated LED.

### RELATED APPLICATION

Under provisions of 35 U.S.C. § 119(e), the Applicant claims the benefit of U.S. Provisional Application No. 63/668,988 filed on Jul. 9, 2024, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to agricultural technology. More specifically, the disclosure pertains to advanced lighting systems designed for enhancing plant growth in indoor cultivation environments.

### BACKGROUND

Existing plant growth systems have been traditionally limited by fixed light spectrums, which do not offer adaptability to changing growth phases of plants. Within agricultural technology, particularly in controlled environment agriculture, the capability to adjust light spectrums to suit different plant growth stages may be beneficial. In existing systems, which often use Metal-Halide and/or High-Pressure Sodium lamps, the spectral output is predetermined and unchangeable without manual intervention. This may lead to inefficiencies, as the spectrum that may be optimal for one stage of plant growth may not be optimal for another.

Additionally, conventional lighting systems often do not incorporate mechanisms that allow for the active management of heat generated by the lighting elements. Excessive heat may negatively affect plant health and reduce the operational lifespan of the lighting equipment, leading to potential disruptions in plant cultivation and increased maintenance costs.

Moreover, typical plant growth lighting systems may lack provisions for modifying the spatial distribution and intensity of light. This may restrict their ability to provide optimal light exposure to plants, which is critical for achieving uniform growth across a plantation. The fixed position and intensity of lighting may result in uneven plant growth, with some plants receiving excessive light while others may not receive enough.

Furthermore, most traditional plant growth lighting setups do not include features that ensure operation continuity during power disruptions or facilitate the inspection and maintenance of plant health under normal lighting conditions. The absence of emergency power solutions and inspection-friendly lighting modes may lead to increased vulnerability to power outages and difficulties in maintaining consistent and effective monitoring of plant conditions.

Another technical limitation of conventional systems is their inability to precisely target specific plant photoreceptors. Plants utilize different photoreceptors (such as phytochromes, cryptochromes, and phototropins) that respond to specific wavelengths of light to regulate various aspects of growth and development. Fixed-spectrum lighting systems cannot selectively activate these photoreceptors in optimal ratios, potentially limiting plant performance across various metrics including biomass production, nutrient content, and secondary metabolite synthesis.

The spatial limitations of traditional lighting setups also present challenges for multi-tiered vertical farming systems, which are increasingly common in urban agriculture. Fixed lighting configurations often cannot be easily adapted to the space constraints and specific requirements of vertically stacked growing platforms. This inflexibility can limit the efficient use of growing space and complicate the implementation of space-saving cultivation techniques.

In addition, conventional lighting systems typically lack integration capabilities with other environmental control systems. This isolation prevents the coordinated management of light, temperature, humidity, and carbon dioxide levels, which are all interconnected factors affecting plant growth. The absence of integrated environmental management can lead to suboptimal growing conditions and missed opportunities for resource optimization.

For research applications, traditional lighting systems present limitations in conducting controlled experiments on plant photobiology. The inability to precisely manipulate specific wavelengths independently makes it difficult for researchers to study the effects of particular light spectra on plant development, limiting scientific advancement in understanding plant-light interactions.

Light Emitting Diode (LED) systems have gained popularity in controlled environment agriculture. Basic LED systems typically feature fixed arrays of diodes that emit light at specific wavelengths, commonly focusing on red and blue spectra which correspond to chlorophyll absorption peaks. Some advanced LED systems incorporate additional diodes to provide a broader spectrum, including green, far-red, and in some cases, ultraviolet wavelengths. Certain commercially available LED fixtures offer limited manual control over spectrum through separate channels for different colored diodes, allowing growers to make basic adjustments to the ratio of red to blue light.

However, these existing solutions present several significant inadequacies for optimal plant cultivation. Even advanced LED systems on the market today have substantial limitations. Many systems that advertise “full spectrum” capabilities actually provide only approximations of natural light with significant gaps in spectral coverage. The control mechanisms in these systems are often rudimentary, offering only coarse adjustments between a few preset spectral configurations rather than precise wavelength-specific control. Furthermore, most LED fixtures maintain fixed positions relative to the plant canopy, resulting in uneven light distribution that can lead to inconsistent growth patterns, particularly as plants develop and their canopy architecture changes.

The thermal management approaches in current lighting systems are also inadequate. Many rely solely on passive heat sinks or basic fan systems that struggle to maintain optimal operating temperatures, especially in enclosed growing environments. This thermal inefficiency not only reduces the operational lifespan of the lighting equipment but also introduces unwanted heat into the growing environment, potentially stressing plants and complicating overall climate control efforts.

Additionally, existing lighting solutions typically lack integration with environmental monitoring systems. This absence of sensor feedback prevents dynamic adjustment of lighting parameters in response to changing environmental conditions or plant developmental stages. Without this adaptive capability, growers must rely on manual observations and adjustments, which are both labor-intensive and potentially imprecise.

This landscape of agricultural lighting technology indicates a general need for enhancements in flexibility, efficiency, and functionality of plant growth lighting systems to better accommodate the unique and changing needs of plant cultivation in controlled environments.

There is a critical need for a comprehensive solution that addresses the multiple deficiencies of current plant growth lighting systems. The agricultural industry requires lighting technology that can simultaneously solve the problems of spectral inflexibility, poor thermal management, inadequate spatial distribution, limited adaptability to changing conditions, vulnerability to power disruptions, and insufficient integration with environmental monitoring systems. A solution that effectively addresses these interconnected challenges would enable growers to optimize plant development throughout all growth stages, maintain consistent production schedules, reduce energy consumption and operational costs, extend equipment lifespan, and ultimately improve crop yields and quality. Without such an integrated approach, indoor cultivation facilities will continue to face significant limitations in achieving the precise environmental control necessary for optimal plant growth, particularly as the industry moves toward more sophisticated vertical farming systems and research applications that demand greater precision in manipulating plant-light interactions.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The present disclosure relates to various embodiments of an apparatus and system that may be used for plant growth illumination. These embodiments include a variety of features such as light emitting diodes, optical lenses, cooling systems, control systems, structural mechanisms, sensors, and user interfaces, each configured to enhance plant growth through controlled lighting conditions.

An apparatus for plant growth illumination may include a plurality of light emitting diodes configured to emit light in a spectrum between 300 nm and 800 nm. A plurality of optical lenses may be individually associated with respective ones of the plurality of light emitting diodes, wherein each optical lens may be adjustable relative to its associated light emitting diode to modify a focus of the emitted light. A cooling system may be integrated with the plurality of light emitting diodes, the cooling system selected from the group consisting of a liquid cooling system and a Peltier cooling system, wherein the apparatus may be configured to maintain an operating temperature of the light emitting diodes at a predetermined value.

Each light emitting diode may be individually addressable to emit light at a specific wavelength within the spectrum based on a growth stage of a plant. A control system may be configured to adjust a distance between each optical lens and its associated light emitting diode based on sensor input indicating a distance from the light emitting diode to a plant canopy. The control system may be further configured to adjust an emitted light intensity and footprint by moving the optical lens closer to or further from its associated light emitting diode. The control system may include a microprocessor for controlling each light emitting diode and optical lens independently based on programmable light spectrum requirements of a plant. A user interface may be configured to allow a user to program the light spectrum requirements for different growth stages of a plant.

A structural mechanism may be configured to adjust a position of the apparatus or portions thereof relative to a plant canopy, the structural mechanism selected from the group consisting of servo motors, linear sliding rods, and a cable system. The structural mechanism may be configured to perform movements selected from the group consisting of linear motion, circular motion, and canopy wrapping motion. The canopy wrapping motion may involve expanding or contracting parts of the apparatus to increase or decrease a coverage area of the emitted light over the plant canopy.

At least one sensor selected from the group consisting of one or more proximity sensors, one or more infrared sensors, one or more photosensors, and one or more temperature sensors may provide input to a control system for dynamically adjusting the light emission based on environmental conditions and plant growth stages. The apparatus may further comprise an emergency lighting mode, including a battery backup system configured to maintain plant photoreactivity during power outages. The emergency lighting mode may include a white light inspection feature for analyzing plant health attributes selected from the group consisting of leaf pests, nutrient deficiencies, and flower colors.

An apparatus for providing spatial light distribution over a plant canopy may comprise a plurality of light sources configured to emit light at varying spectrums, a support structure maintaining the plurality of light sources, and a motorized adjustment mechanism coupled with the support structure, configured to alter a position of the plurality of light sources relative to the plant canopy. The motorized adjustment mechanism may be configured to move the plurality of light sources in at least one of a vertical and horizontal direction relative to the plant canopy.

An apparatus for adjustable spatial light distribution over a plant canopy may comprise a lighting assembly including a plurality of light emitting diodes, and a controllable movement system operatively connected to the lighting assembly, configured to adjust a position of the lighting assembly over the plant canopy. The controllable movement system may be capable of expanding or contracting the lighting assembly to vary the distribution of light over the plant canopy.

The embodiments disclosed herein should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment of a lighting system for indoor cultivation of plants consistent with the present disclosure;

FIG. 2 illustrates a structural diagram of the lighting system for indoor cultivation of plants;

FIG. 3A shows a line drawing of a lighting module for use with the lighting system for indoor cultivation of plants;

FIG. 3B shows a schematic view of a lighting module for use with the lighting system for indoor cultivation of plants, in a closed position;

FIG. 3C shows a schematic view of a lighting module for use with the lighting system for indoor cultivation of plants, in an intermediate position;

FIG. 3D shows a schematic view of a lighting module for use with the lighting system for indoor cultivation of plants, in an open position;

FIG. 4 shows a diagram of the photosynthetically active radiation and relative quantum yield, by wavelength of light;

FIG. 5 shows a close-up view of a portion of the lighting module;

FIG. 6 shows a cooling system for use with the lighting system for indoor cultivation of plants; and

FIG. 7 is a block diagram of a system including a computing device for use with the lighting system for indoor cultivation of plants.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The programmable lighting system may be used to optimize or otherwise improve plant growth in indoor cultivation environments. This system features adjustable light spectra, optical focusing, cooling mechanisms, and dynamic positioning capabilities to enhance plant growth through controlled lighting conditions.

The lighting system described herein addresses several technical problems associated with traditional plant growth illumination systems. Conventional plant growth lighting systems typically offer fixed light spectrums which may not be adaptable to the changing needs of plants throughout their growth cycles. Plants require different light spectrums during various growth stages, such as vegetation, flowering, and fruiting. For example, blue-dominant light may be beneficial during vegetative growth to promote compact, bushy plants, while red-dominant light may be more advantageous during flowering to encourage robust bud development. Traditional lighting systems may necessitate the physical replacement of lighting fixtures to accommodate these changing requirements, which may be inefficient, labor-intensive, and potentially disruptive to plant growth.

Another technical problem addressed by the present system relates to heat management. Conventional lighting systems may generate excessive heat that can negatively impact plant health and reduce the operational lifespan of the lighting equipment. This excess heat may raise ambient temperatures in growing environments beyond optimal levels for plant growth, potentially leading to heat stress, reduced yields, and increased water consumption. Additionally, excessive heat may compromise the quality and consistency of light output from the lighting elements, particularly LEDs, whose performance and longevity may be significantly affected by operating temperature.

The spatial distribution of light presents a further technical challenge in traditional growing systems. Fixed-position lighting may result in uneven light distribution across plant canopies, with some areas receiving excessive light while others remain under illuminated. This uneven distribution may lead to inconsistent plant growth, with some portions of plants developing more robustly than others. The lack of light penetration through dense plant canopies may further exacerbate this issue, particularly in commercial growing operations where maximizing yield per square foot may be critical.

The lighting system described herein may address these (and other) technical problems through a combination of individually addressable LEDs, adjustable optical lenses, advanced cooling systems, dynamic positioning capabilities, and intelligent control mechanisms. For example, the system may allow for real-time adjustment of light spectrums to match specific plant growth stages without requiring physical replacement of lighting fixtures. The integrated cooling system may help to maintain optimal (or nearly optimal) operating temperatures for the LEDs, enhancing their performance and longevity while preventing heat stress to plants. The motion capabilities may improve spatial light distribution and canopy penetration, promoting more uniform plant growth and potentially increasing yields. Additionally, the emergency lighting mode with battery backup may maintain essential light exposure during power outages, protecting plants from stress and potential damage.

In various scenarios, the lighting system may be employed in different growing environments. In a commercial vertical farming operation, the system may be programmed to emit specific light spectrums optimized for leafy greens, with the motion module adjusting the position of the lighting elements to ensure even light distribution across multiple growing tiers. In a research facility, the system may be used to study the effects of different light spectrums on plant growth, with the control system collecting and analyzing data on plant responses to various lighting conditions. In a home growing environment, the system may be configured to provide optimal or otherwise improved lighting for a variety of plants, including herbs, flowering plants, and/or the like. A user interface may allow for easy and intuitive adjustment of lighting parameters based on specific plant needs.

In addressing the technical problems associated with traditional plant growth lighting systems, the programmable lighting system described herein may provide an innovative solution through its combination of individually addressable LEDs, adjustable optical elements, advanced cooling mechanisms, and dynamic positioning capabilities.

The system may incorporate a control module that allows users to program specific light spectrums tailored to different plant growth stages. For example, during vegetative growth, the system may be configured to emit predominantly blue light (approximately 450-495 nm) to promote compact, bushy growth and strong stem development. As plants transition to flowering or fruiting stages, the system may shift to a spectrum with increased red light (approximately 620-750 nm) to stimulate reproductive development. This programmability may eliminate the need to physically replace lighting fixtures when transitioning between growth stages, potentially saving time, reducing disruption to plants, and improving resource efficiency.

The cooling system integrated with the LEDs may be particularly beneficial in maintaining optimal operating conditions. By incorporating either liquid cooling or Peltier cooling technologies, the system may efficiently transfer heat away from the LEDs, potentially extending their operational lifespan and maintaining consistent light quality. The cooling system may be dynamically adjusted based on temperature readings from sensors positioned near the LEDs, ensuring that operating temperatures remain at approximately 80 degrees Fahrenheit or another predetermined value that optimizes LED performance while minimizing heat stress to plants.

The adjustable optical lenses associated with each LED may provide significant flexibility in controlling light distribution. By modifying the distance between each lens and its associated LED, the system may adjust the focus and intensity of emitted light. Moving a lens closer to its LED may produce a more focused beam that penetrates deeper into the plant canopy, while increasing the distance may create a broader light footprint that covers a wider area. This capability may be particularly valuable for accommodating plants of different heights or growth habits, or for adjusting light distribution as plants mature and their canopy architecture changes.

The motion capabilities of the system may further enhance light distribution and penetration. The structural mechanism may enable various movement patterns, including linear motion along horizontal or vertical axes, circular rotation, and canopy wrapping motion that expands or contracts portions of the lighting assembly. These movements may help to reduce shadowing within the plant canopy and ensure more uniform light exposure across all parts of the plant. Empirical evidence suggests that moving light sources may result in additional photons penetrating the plant canopy, potentially leading to more efficient photosynthesis and improved plant growth.

In commercial applications, the system may be implemented in vertical farming operations where space efficiency is critical. The ability to adjust light focus and distribution may allow for optimal illumination of plants grown on multiple tiers, while the cooling system may help manage ambient temperatures in densely packed growing environments. The programmable spectrum may enable the cultivation of diverse crop types within the same facility, each receiving its optimal light recipe.

For research applications, the system may provide precise control over light conditions, allowing scientists to study the effects of specific wavelengths or light patterns on plant development. The integrated sensors may collect valuable data on plant responses to different lighting conditions, potentially contributing to the advancement of horticultural lighting science.

In home gardening scenarios, the user-friendly interface may allow hobbyists to select pre-programmed light recipes optimized for common houseplants, herbs, or vegetables. The emergency lighting mode with battery backup may provide peace of mind by maintaining essential light exposure during power outages, protecting valuable plants from stress or damage.

The present disclosure includes many aspects and features. Moreover, while many aspects and features relate to, and are described in, the context of a lighting system for indoor cultivation of plants, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The programmable lighting system described in this disclosure represents an innovative approach to indoor plant cultivation through advanced light management. This system addresses several key challenges in traditional plant growth lighting by combining individually controllable LED technology, adaptive optical focusing, efficient cooling mechanisms, and dynamic positioning capabilities.

At its core, the system features light emitting diodes (LEDs) that can emit light across the photosynthetically active radiation spectrum (300-800 nm). Unlike conventional fixed-spectrum lighting systems, each LED in this system may be individually programmed to emit specific wavelengths tailored to different plant growth stages. For example, blue-dominant light may be used during vegetative growth to promote compact, bushy plants, while red-dominant light may be employed during flowering to encourage robust bud development.

The system's optical design includes adjustable lenses paired with each LED, allowing for precise control over light focus and distribution. By modifying the distance between each lens and its associated LED, users may adjust the intensity and coverage area of the emitted light. This feature enables optimal light penetration through plant canopies and ensures uniform illumination across growing areas.

Heat management, a critical challenge in indoor cultivation, is addressed through an integrated cooling system that may utilize either liquid cooling or Peltier cooling technologies. This system maintains optimal operating temperatures for the LEDs (approximately 80 degrees Fahrenheit), enhancing their performance and longevity while preventing heat stress to plants.

Perhaps most innovative is the system's motion capability, which allows the lighting elements to move relative to the plant canopy. This movement may include linear motion along horizontal or vertical axes, circular rotation, or “canopy wrapping” motion that expands or contracts portions of the lighting assembly. These dynamic positioning features help to reduce shadowing within plant canopies and ensure more uniform light exposure across all parts of the plants.

The entire system is managed by an intelligent control system that may include user-friendly interfaces for programming light recipes, sensors for monitoring environmental conditions, and even machine learning capabilities for optimizing lighting conditions based on plant responses. An emergency lighting mode with battery backup provides additional protection during power outages.

By combining these advanced features, the programmable lighting system offers a comprehensive solution for indoor plant cultivation that may improve growth rates, increase yields, and enhance overall plant quality across various applications from commercial agriculture to home gardening.

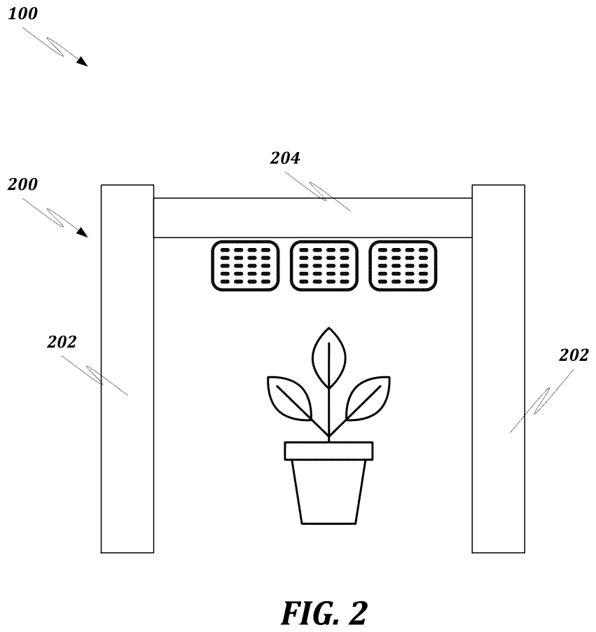

As shown in FIG. 2, a plant growth system 100 may include a frame 202 that is disposed in the vicinity of at least one plant. The frame 202 may include one or more vertical supports 204 which support a moveable and programmable lighting element 206. The system 100 may further include hardware and/or software designed to control at least the movement of the lighting element and one or more characteristics of light emitted by the lighting element. The system 100 may further include a cooling system that uses hardware and/or software to maintain at least a portion of the system within a defined operating temperature range.

A plant growth system may include a lighting unit for plant illumination to enhance growth of various plants. As examples, the plants may include, but need not be limited to, flowers, herbs, microgreens, lettuces, cabbages, kales, and/or cannabis plants. The lighting unit may include multiple light emitting diodes (LEDs) which can emit light spanning a spectrum from 300 nm to 800 nm. Each LED in the system may be coupled with an optical lens that is capable of adjusting its position relative to the associated LED, thereby allowing modification of the focus and intensity of the emitted light. This adjustment may help to control the light distribution according to different plant growth stages.

A cooling system may be integrated with the LEDs to ensure that the temperature around the LEDs is maintained at a manageable level. This cooling system may include options such as (but not limited to) air cooling, liquid cooling, and/or Peltier cooling technologies, which may be selected based on specific requirements related to the environmental conditions and/or the specific setup of the plant growth system.

The system may also feature a control mechanism that allows each LED to be individually programmable. This capability may enable the emission of light at specific wavelengths that cater to the unique needs of various plant species, plant growth phases, plant traits, and/or the like. The control system may include a microprocessor that facilitates the independent operation of each LED and optical lens.

Further, the system may incorporate structural mechanisms that enable the adjustment of the position of the apparatus or parts of thereof in relation to the plant canopy. These adjustments may be executed through mechanisms such as (but not limited to) servo motors, solenoids, and/or linear sliding rods, allowing for movements such as linear motion, circular motion, or canopy wrapping motion.

Additionally, sensors such as proximity sensors, infrared sensors, and temperature sensors may be included. These sensors may provide inputs to the control system, enabling dynamic adjustments of the light emission based on detected environmental conditions or specific growth stages of the plants.

In scenarios of power outages, the system may incorporate an emergency lighting module, which may be activated. The emergency lighting module may include a battery backup system to maintain the photoreactivity of the plants. Moreover, this emergency mode may feature a white light inspection attribute useful for analyzing plant health aspects such as leaf pests, nutrient deficiencies, and flower colors.

Furthermore, the system may have the capability to expand or contract its physical structure, which may include an expandable mechanical rail system operated by actuators. This feature allows the spatial distribution of light over the plant canopy to be varied effectively.

Each element of the system may be housed within a modular unit. These units may be interconnected to scale the system according to the size and complexity of the plant growing operation, facilitating a comprehensive and adaptable plant growth illumination system.

Overall, the system represents a multifaceted solution for helping to optimize plant growth through advanced lighting technology, cooling systems, and structural adaptability, providing a customizable environment that can be tailored to meet the diverse needs of various plant species throughout their growth cycles.

Embodiments of the present disclosure may comprise methods, systems, and a computer readable medium comprising, but not limited to, at least one of the following:
A. A Lighting Module;
B. A Cooling System;
C. A Motion Module;
D. A Control System;

In some embodiments, the present disclosure may provide an additional set of modules for further facilitating the software and hardware platform. The additional set of modules may comprise, but not be limited to:
E. One or More Sensors; and
F. Peripheral Devices.

Details with regards to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

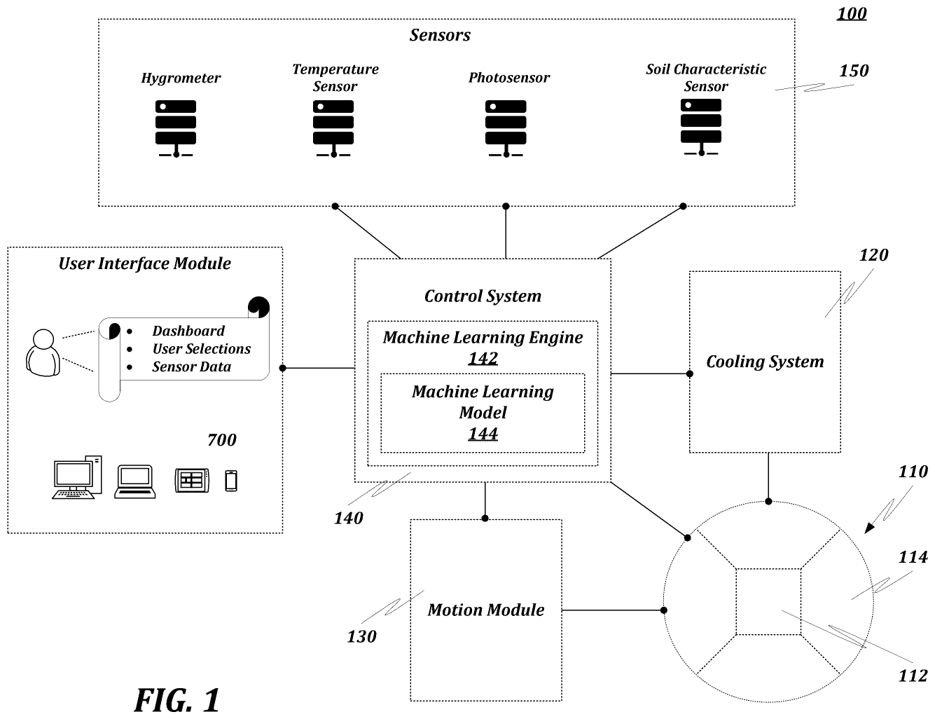

FIG. 1 illustrates one possible operating environment through which a platform consistent with embodiments of the present disclosure may be provided. By way of non-limiting example, various elements of lighting system or platform 100 for indoor cultivation of plants may be hosted on, for example, a cloud computing service. In some embodiments, the platform 100 may include a computing device 700. A user may access platform 100 through a software application and/or hardware device. The software application may be embodied as, for example, but not be limited to, a website, a web application, a desktop application, a mobile application, and/or any other interface compatible with the computing device 700.

Embodiments of the lighting platform 100 incorporate several advanced features designed to optimize plant growth through controlled lighting conditions.

The lighting module 110 may include a plurality of individually addressable light emitting diodes (LEDs). In some embodiments, each of the LEDs may be capable of emitting light at least across the photosynthetically active radiation spectrum from 300 nm to 800 nm. Each LED may be paired with an adjustable optical lens that can be moved closer to or further from its associated LED to modify the focus and intensity of the emitted light. This adjustability may allow for precise control over light distribution, enabling users to optimize illumination based on specific plant requirements, growth stages, and canopy architecture.

The cooling system 120 may be implemented as a liquid cooling system, a vapor cooling system, a Peltier cooling system, and/or other cooling systems that may operate to maintain optimal operating temperatures for the LEDs. In the liquid cooling configuration, the system may include a reservoir 122 containing coolant, a baseplate 124 adjacent to the LEDs for heat absorption, a radiator 126 for heat dissipation, and optional fans 128 to enhance cooling efficiency. The cooling system may be dynamically adjusted based on temperature readings from sensors positioned near the LEDs, maintaining the operating temperature at approximately 80 degrees Fahrenheit to optimize LED performance and longevity while preventing heat stress to plants.

The motion module 130 may enable various movement patterns of the lighting elements relative to the plant canopy. These movements may include linear motion along horizontal or vertical axes, circular rotation, and canopy wrapping motion that expands or contracts portions of the lighting assembly. The motion capabilities may be facilitated through mechanisms such as servo motors, linear sliding rods, cable systems, or electromechanical actuators. This dynamic positioning may help to reduce shadowing within the plant canopy and ensure more uniform light exposure across all parts of the plants, potentially improving photosynthetic efficiency. In embodiments, the motion capabilities may apply to the lighting module 110 as a whole, or subsets thereof.

The control system 140 may manage various aspects of the lighting system operation, including (but not necessarily limited to) LED spectrum control, lens positioning, cooling system management, and motion control. The control system 140 may include a user interface allowing programmable light recipes based on plant growth stages, species requirements, or environmental conditions. In some embodiments, the control system may incorporate a machine learning engine 142 with trained models 144 to optimize lighting conditions based on plant responses and environmental feedback.

The system may include various sensors 150 such as temperature sensors, proximity sensors, photosensors, infrared sensors, and/or the like. These sensors may provide input to the control system for dynamically adjusting light emission based on environmental conditions and plant growth stages. For example, photosensors installed near the base of plants may measure light penetration through the canopy, allowing the system to adjust focus and intensity accordingly.

An emergency lighting mode with battery backup may be incorporated to maintain essential light exposure during power outages. This mode may include a white light inspection feature for analyzing plant health attributes such as leaf pests, nutrient deficiencies, and flower colors.

The entire system may be designed with modularity in mind, allowing components to be interconnected to scale according to the size and complexity of the plant growing operation. The structural framework may enable movement in at least one axis to adjust spatial distribution of light across the plant canopy, while the expandable mechanical rail system may allow for adjustments in spacing between lighting components.

Through this combination of advanced features, the programmable lighting system may provide a comprehensive solution for indoor plant cultivation, potentially improving growth rates, increasing yields, and enhancing overall plant quality across various applications from commercial agriculture to home gardening.

Accordingly, embodiments of the present disclosure provide a software and hardware platform comprised of a distributed set of computing elements, including, but not limited to:

### A. A Lighting Module

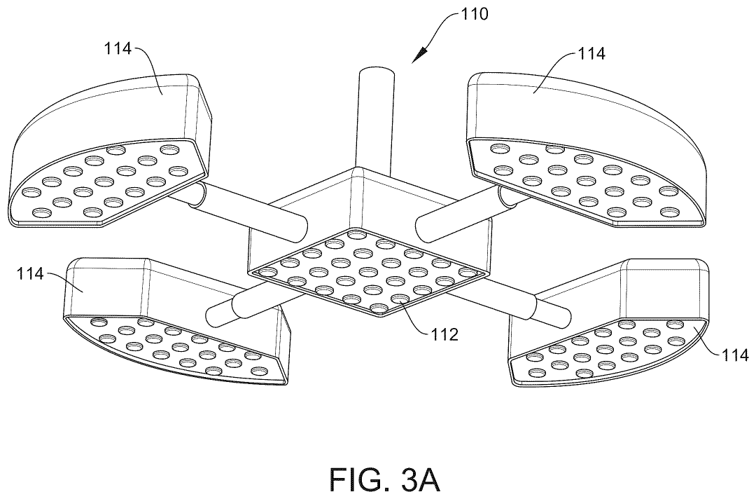

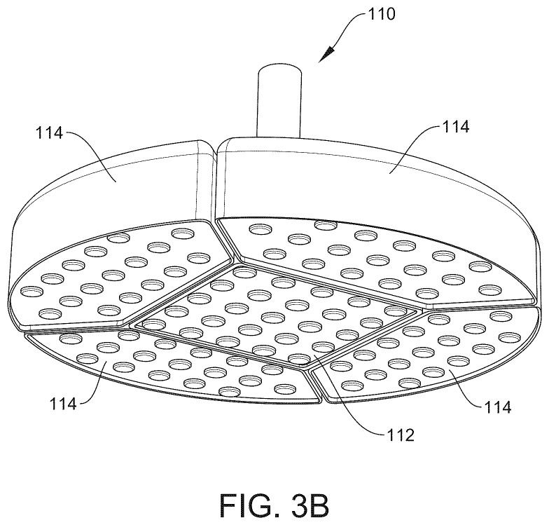

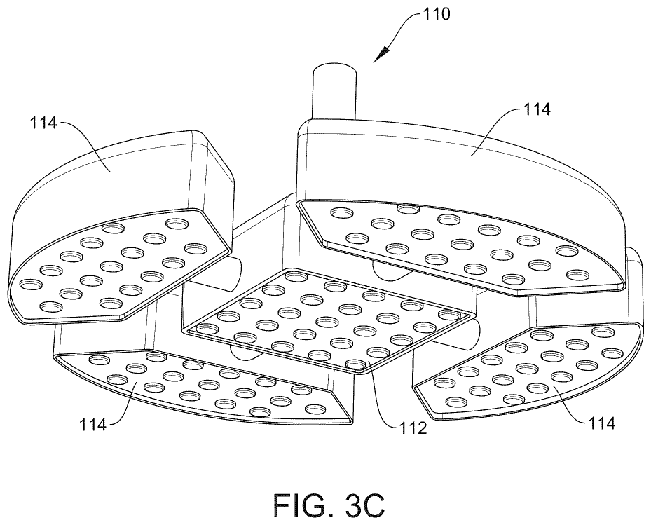

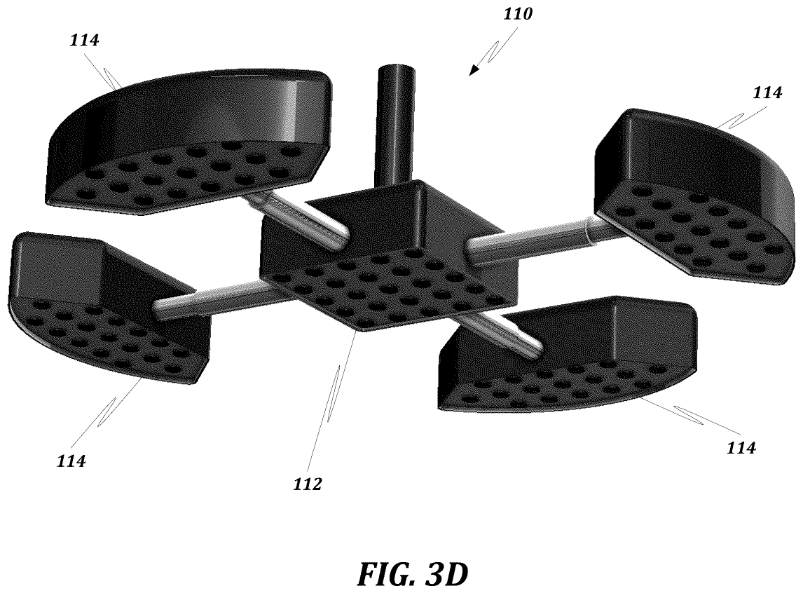

The platform 100 may include a lighting module 110, which may be divided into a central hub 112 and plurality of submodules 114. Each submodule 114 may be movable relative to the central hub 112. For example, the submodules may be mounted on rails or rods to permit motion relative to the hub. In embodiments, as shown in FIGS. 3A-3D, the hub 112 is disposed centrally, and the submodules 114 move radially relative to the central hub.

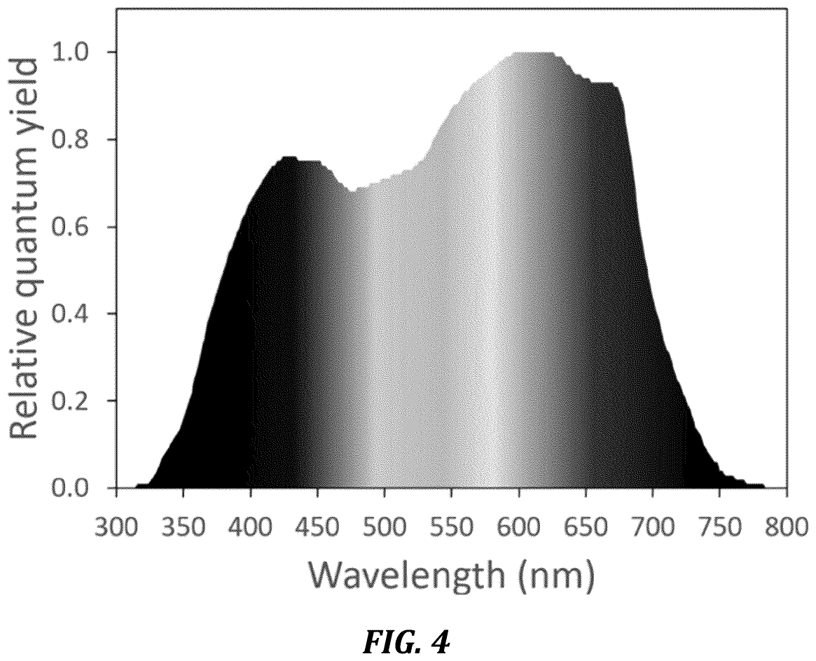

The lighting module 110 (e.g., the central hub 112 and/or at least one submodule 114) may be equipped with a plurality of light emitting diodes (LEDs). One or more (e.g., each) of the LEDs may be capable of producing light at least in the spectrum of visible light. In some embodiments, one or more of the LEDs may be capable of producing light in the infrared (e.g., wavelengths between about 780 nm and about 1 mm) and/or ultraviolet (e.g., wavelengths between about 100 nm and about 400 nm) ranges. The infrared and/or ultraviolet light production may be in addition to or in place of light production in the visible range. As one example, the LEDs may be capable of producing light in a spectrum having wavelengths that range from 300 nm to 800 nm (e.g., within the photosynthetic light spectrum, spanning near-infrared, visible, and long wave ultraviolet spectrums, as shown in FIG. 4). In embodiments, one or more (e.g., each) of the LEDs may be capable of emitting light at any frequency within at least one of the ultraviolet range, the visible light range, and/or the infrared range. For example, one or more (e.g., each) of the LEDs may be individually addressable to specify a wavelength of light to be emitted by that particular LED. In embodiments, the wavelength of the emitted light may be selected based at least in part on one or more factors such as user preferences, plant growth stages, specific plant species requirements, and/or environmental details. As one example, for certain species of cannabis plants, subjecting the plant to a red light may cause the plant to grow taller, while blue light may cause the plant to remain more compact.

In some embodiments, one or more of the LEDs may produce light at a fixed wavelength within the photosynthetically active range. For example, the diodes may produce or emit light in the range of red (e.g., 620-750 nm) or blue (e.g., 450-495 nm) light. The light produced by each LED may comprise photosynthetically active radiation to activate chlorophyll and facilitate photosynthesis in plants.

In some embodiments, the variation of light colors and/or intensities may allow for an increased daily light integral for the plant, when compared to comparable plants in their natural environments. In particular, plants may receive additional light alone or in conjunction with other additional resources (e.g., nutrients and/or water), allowing the growing process to be sped up and/or allowing the plant to grow larger than is typical of that plant.

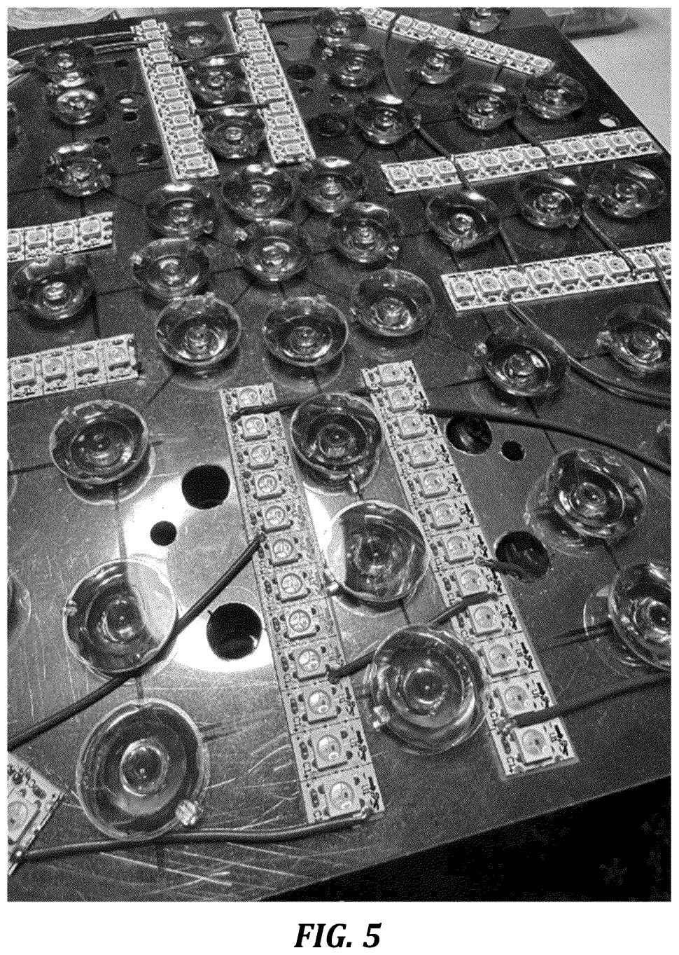

FIG. 5 shows a closeup of one portion of the lighting module 110. As shown in FIG. 5, One or more (e.g., each) of the LEDs in the lighting module 110 may be paired with an optical lens. In some embodiments, each LED may be paired with an individual optical lens. In other embodiments, a single optical lens may be paired with a plurality of LEDs.

In some embodiments, each optical lens may be moveable relative to the one or more paired LEDs to adjust a distance between the LEDs and the lens. Adjusting the distance between the LEDs and the lens helps to modify the focus and intensity of the light emitted from the lighting module. This adjustment may allow for varying light dispersal patterns to accommodate different plant growth stages, specific plant species requirements, environmental details, and/or user preferences. In particular, moving the lens nearer to the LED may reduce intensity of the light, at the base of the plant and instead focus the intensity towards a plant canopy. Conversely, moving the lens further from the LED may cause the light to be focused at the base on the plant, reducing the spread of the light at the plant base and facilitating penetration of the light through the canopy to reach the plant base.

In other embodiments, where the lens is at a fixed distance relative to the LEDs. The lens may include a plurality of lens parts, and different combinations of lens parts may be interposed between the LED and the planting area to adjust the focusing distance of the light emitted by the LED, similar to a phoropter used by an optometrist.

### B. A Cooling System

The apparatus 100 may include a cooling system 120. The cooling system 120 may be configured to transfer heat energy from the LEDs to the cooling system, where the heat can be dissipated or otherwise exhausted. For example, the cooling system 120 may be configured to prevent the temperature of the LED from exceeding a threshold temperature and/or to maintain the LEDs at a desired operating temperature. This cooling system may include options such as liquid cooling, vapor cooling, thermoelectric (e.g., Peltier effect) cooling, and/or any other cooling system which may be effective in preventing overheating of the LEDs and/or maintaining the LEDs within their optimal temperature range, thus enhancing their performance and longevity.

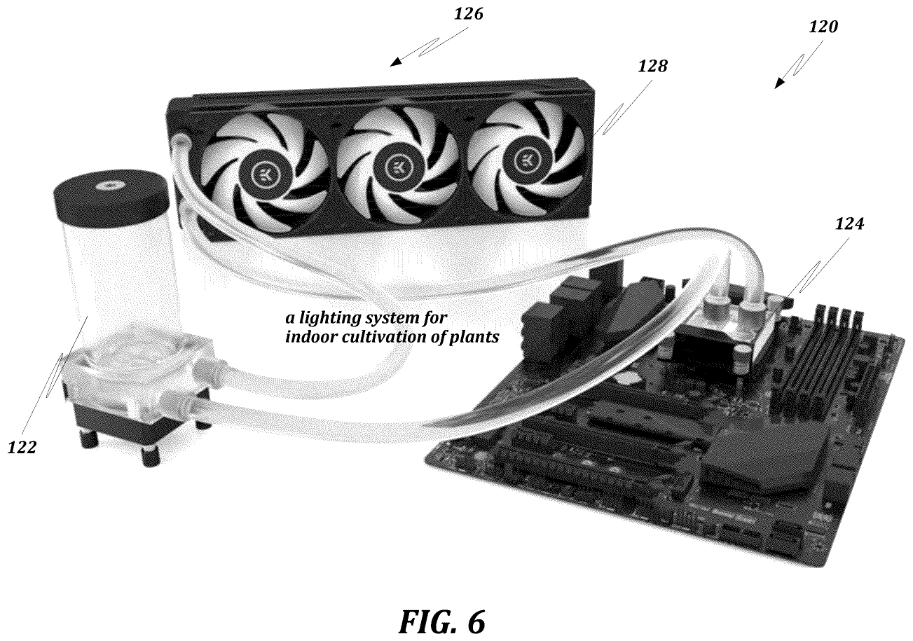

In some embodiments, as shown in FIG. 6, the cooling system 120 comprises a liquid cooling system. The liquid cooling system provides several advantages over conventional air cooling methods, particularly in maintaining optimal operating temperatures for the LEDs while preventing heat stress to nearby plants.

The liquid cooling configuration may include a closed-loop system where a coolant circulates through components specifically designed to transfer heat away from the LEDs. The coolant may be a specialized heat transfer fluid with high thermal conductivity and low electrical conductivity to ensure efficient heat removal while preventing electrical hazards in case of leaks.

As illustrated in FIG. 6, the liquid cooling system begins with a reservoir 122 that contains the coolant. The reservoir 122 may be constructed from materials resistant to corrosion and degradation, such as high-grade plastics or treated metals, and may include features such as fill ports, drain valves, and sight glasses to monitor coolant levels.

From the reservoir 122, the coolant flows through a first tube or duct to a baseplate 124 that is thermally coupled to the LEDs. The baseplate 124 may be manufactured from materials with high thermal conductivity such as copper or aluminum and may feature microchannels or fins on its internal surface to increase the contact area between the coolant and the baseplate, enhancing heat transfer efficiency. The baseplate 124 may be directly attached to the LED substrate using thermal interface materials to minimize thermal resistance between the LEDs and the cooling system.

As the coolant passes through the baseplate 124, it absorbs heat from the LEDs, causing the coolant temperature to rise while simultaneously reducing the temperature of the LEDs. This heat exchange process helps maintain the LEDs at their optimal operating temperature of approximately 80 degrees Fahrenheit, which is critical for maximizing LED performance and longevity.

The heated coolant then exits the baseplate 124 through a second tube or duct and flows to a radiator 126 located away from the plant growing area. This remote positioning of the radiator 126 is advantageous as it allows the heat to be dissipated away from the plants, preventing unwanted temperature increases in the growing environment. The radiator 126 may feature multiple thin fins to maximize surface area for heat dissipation and may be constructed from materials with high thermal conductivity.

To enhance the cooling efficiency of the radiator 126, optional fans 128 may be attached to force air across the radiator fins. These fans 128 may be variable speed, adjusting their rotation based on temperature readings to optimize cooling while minimizing power consumption and noise. The control system 140 may regulate fan speed based on inputs from temperature sensors located near the LEDs, at the radiator, and in the ambient environment.

After passing through the radiator 126 and releasing its heat to the surrounding air, the cooled coolant returns to the reservoir 122 through a third tube, completing the closed loop. The continuous circulation of coolant is typically maintained by a pump (not shown in FIG. 6) that may be integrated with the reservoir 122 or installed as a separate component in the loop. The pump may be selected for quiet operation, reliability, and appropriate flow rate to ensure efficient heat transfer without creating excessive pressure in the system.

The liquid cooling system may also incorporate additional components for enhanced performance and safety, such as flow meters to monitor coolant circulation, pressure relief valves to prevent over-pressurization, and temperature sensors at various points in the loop to provide feedback to the control system 140. Anti-microbial additives may be included in the coolant to prevent algae or bacterial growth within the system.

In some embodiments, the liquid cooling system may feature quick-disconnect fittings that allow for easy maintenance or reconfiguration of the lighting system without draining the entire cooling loop. The tubing used throughout the system may be constructed from materials resistant to UV degradation and physical damage, with appropriate insulation to prevent condensation on cold surfaces.

The efficiency of the liquid cooling system enables the LEDs to operate at higher power levels without risk of thermal damage, potentially increasing light output and improving plant growth rates compared to systems with less effective cooling solutions. Additionally, by maintaining consistent operating temperatures, the liquid cooling system helps ensure uniform light output and color consistency across all LEDs in the lighting module 110.

The cooling system 120 may alternatively or additionally incorporate vapor cooling technology to efficiently manage heat generated by the LEDs. The vapor cooling system utilizes the principles of phase change heat transfer to provide effective thermal management for the lighting module 110.

In a vapor cooling configuration, the system includes a sealed chamber containing a working fluid with appropriate thermodynamic properties. The chamber is thermally coupled to the baseplate 124 adjacent to the LEDs. As the LEDs generate heat during operation, the working fluid near the baseplate absorbs this thermal energy and transitions from liquid to vapor state. This phase change process is highly efficient at absorbing heat energy.

The vapor then naturally rises within the sealed chamber to a condenser section located away from the LEDs. The condenser section may incorporate cooling fins or a secondary heat exchanger that allows the vapor to release its thermal energy to the surrounding environment. As the vapor cools, it condenses back into liquid form and returns to the baseplate area through gravity or through a capillary structure such as a wick.

This continuous cycle of evaporation and condensation creates a highly efficient heat transfer mechanism that requires no pumps or moving parts in its basic implementation. The passive nature of vapor cooling provides reliable operation with minimal maintenance requirements. For enhanced performance, the vapor cooling system may be augmented with small fans directed at the condenser section to improve heat dissipation rates.

The vapor cooling system may be particularly advantageous in situations where silent operation is desired, as it eliminates the noise associated with pump-based liquid cooling systems. Additionally, the absence of moving parts reduces potential points of failure, potentially increasing the overall reliability of the cooling system.

Temperature sensors positioned at key locations within the vapor cooling system provide feedback to the control system 140, allowing for monitoring of the cooling performance. If temperature readings approach predetermined thresholds, the control system may adjust LED output or activate supplementary cooling mechanisms to maintain optimal operating conditions.

The working fluid used in the vapor cooling system is selected based on its thermodynamic properties, including boiling point, latent heat of vaporization, and compatibility with the materials used in the cooling system construction. Common working fluids may include specialized refrigerants or other thermally efficient substances with appropriate phase change characteristics at the desired operating temperatures.

For applications requiring enhanced cooling capacity, the vapor cooling system may be implemented in conjunction with the previously described liquid cooling system, creating a hybrid approach that leverages the advantages of both cooling technologies to maintain optimal LED operating temperatures under varying conditions.

In some embodiments, where the cooling system 120 comprises a thermoelectric cooler, the cooling system may use the Peltier effect to create a heat flux at the junction of two different types of materials. The cooling system 120 may incorporate thermoelectric cooling technology as an alternative or complementary approach to the liquid cooling system previously described. Thermoelectric cooling, based on the Peltier effect, offers several unique advantages for maintaining optimal LED operating temperatures in the plant growth lighting system. A Peltier cooler, or thermoelectric heat pump is a solid-state active heat pump which transfers heat from one side of the device to the other, with consumption of electrical energy. Thermoelectric coolers operate by the Peltier effect. A thermoelectric module may include three components; the conductors, legs, and the substrate, connected electrically in series, but thermally in parallel. When a DC electric current flows through the device, it brings heat from one side to the other, so that one side gets cooler while the other gets hotter. The “hot” side is attached to a heat sink so that it remains at ambient temperature, while the temperature of the cool side is reduced. In some applications, multiple coolers can be cascaded or staged together for lower temperature, but overall efficiency drops significantly. In embodiments, the thermoelectric cooler may be utilized on its own to lower the temperature of the LEDs, or may be used as a part of a liquid cooler (e.g., as the radiator of the liquid cooler).

In a thermoelectric cooling configuration, the system utilizes solid-state devices known as Peltier modules. Each Peltier module consists of arrays of semiconductor materials (typically bismuth telluride) sandwiched between two ceramic plates. When direct current is applied to the module, heat is transferred from one side to the other, creating a temperature differential across the device. This phenomenon allows the module to function as a heat pump without any moving parts.

The thermoelectric cooling implementation in the cooling system 120 positions the cold side of the Peltier modules in direct thermal contact with the baseplate 124 supporting the LEDs. The hot side of the modules connects to a heat sink or may be integrated with the previously described liquid cooling system to enhance heat dissipation efficiency. This arrangement creates a direct thermal pathway for heat to be actively pumped away from the LEDs.

Temperature sensors embedded near the LEDs provide feedback to the control system 140, which modulates the electrical current supplied to the Peltier modules. This precise control allows the system to maintain the LED operating temperature at the predetermined value of approximately 80 degrees Fahrenheit, optimizing both LED performance and longevity.

The thermoelectric cooling approach offers several benefits specifically relevant to the plant growth lighting system. Unlike liquid cooling, thermoelectric cooling has no risk of coolant leaks that could potentially damage electrical components or harm plants. The solid-state nature of Peltier devices means there are no moving parts to wear out, potentially increasing reliability and reducing maintenance requirements. Additionally, the compact size of Peltier modules allows for a more streamlined design in certain applications where space constraints are a consideration.

The control system 140 may be programmed to dynamically adjust the power supplied to the Peltier modules based on real-time temperature readings and LED operational parameters. During periods of high-intensity light output, when LEDs generate more heat, the system increases cooling power. Conversely, during lower intensity operations, the system reduces power to the cooling modules, optimizing energy efficiency.

For applications requiring enhanced cooling capacity, the system may implement a cascaded thermoelectric cooling arrangement, where multiple Peltier modules are stacked to achieve greater temperature differentials. This configuration may be particularly valuable for installations in environments with elevated ambient temperatures or for high-power LED arrays that generate substantial heat.

The thermoelectric cooling system may also incorporate heat spreaders made of highly thermally conductive materials such as copper or graphene to efficiently distribute heat across the cold side of the Peltier modules. This ensures uniform cooling across the LED array, preventing localized hot spots that could affect light output consistency or reduce LED lifespan.

In hybrid cooling configurations, the thermoelectric system may work in conjunction with the liquid cooling system previously described. In this arrangement, the hot side of the Peltier modules connects to the liquid cooling baseplate, allowing the liquid system to efficiently remove heat from the thermoelectric modules. This combination leverages the precise temperature control of thermoelectric cooling with the high heat capacity and transfer efficiency of liquid cooling.

The integration of thermoelectric cooling technology into the cooling system 120 provides the plant growth lighting system with additional flexibility in thermal management approaches, allowing for customization based on specific installation requirements, environmental conditions, and operational parameters.

The functionality of the cooling system 120 may be dynamically adjusted based on the diode temperatures of one or more of the LEDs and/or the ambient environmental conditions. In some embodiments, the cooling system may be used to prevent diode temperature sensors from exceeding a maximum threshold temperature (e.g., 90° F., 80° F., etc.). In some embodiments, the threshold temperature may be selected to improve the life of the diode. In embodiments, a grower may select a different threshold temperature based on plant requirements and/or other heating or cooling concerns. If diode temperatures are approaching or exceeding the threshold temperature, the cooling system 120 may turn on and/or be turned up to reduce the temperature at the diode. Maintaining these temperatures may improve the life of the diode and/or improve the quality (e.g., the color accuracy) of the light emitted by the diode. Maintaining these temperatures may also help to reduce excess heat in the vicinity of the plants being grown, helping to keep the plant environment more consistent.

For controlling the operation of the LEDs and the cooling system, the apparatus may be provided with a control system that includes a microprocessor. This control system may be programmed to adjust the light spectrum emitted by each LED independently, allowing for a customizable lighting environment. The control system may also adjust the cooling system based on the temperature readings obtained from the sensors, ensuring that the LEDs operate within the optimum temperature range.

### C. A Motion Module

Spatial light distribution is the amount of distribution of light, the opposite of shadows. It refers to the way that light spreads across a given area. More light sources means less area in shadow, resulting in more light penetrating through the canopy of the plant. Deeper light penetration is associated both with more yields per plant (e.g., in the case of a fruiting or flowering plant, more fruiting or flowering) and faster yields (e.g., less time from planting to fruiting or flowering, less time until maturation of the fruit or flower, less time between fruitings or flowerings, and/or the like). Empirical evidence suggests that twisting/panning/rotating the LEDs above/over a plant results in additional photons penetrating the plant canopy. In particular, the added motion of the light allows for the plant to absorb a greater number of the photons emitted from the lighting element, meaning that the plant receives more photosynthetically active radiation without the need to increase power directed to the LEDs.

To improve the spatial light distribution over the plant canopy, the apparatus may include a motion module 130 that allows for the adjustment of the position of the entire lighting module 110 and/or individual parts thereof, relative to the plant. The motion module 130 may be capable of causing movements of the lighting module 110 such as (but not limited to) linear motion, circular motion, or canopy wrapping motion. In some embodiments, the motion module 130 may include one or more of servo motors, gears, linear sliding rods, electromechanical actuators, and/or a cable system to facilitate movement of the lighting element. Additionally or alternatively, the motion module 130 may include a series of weights and balances, spools of wire, or servo motors to enable precise control over the movement of the lighting module 110. This may allow for optimal light distribution based on environmental conditions and/or plant growth stages.

In embodiments, the motion module 130 may cause movements of the lighting module 110 by, as non-limiting examples, twisting at least a portion of the lighting element over the plant via a slip ring, gears, and/or other mechanisms, spinning at least a portion of the lighting element, causing translatory motion of the lighting element (e.g., along the x-axis and/or the z-axis relative to the lighting element), and/or any other movement of the lighting element in a patterned or continuous motion, In some embodiments, the motion module 130 may cause the lighting module 110 to spin and move linearly substantially simultaneously.

In some embodiments, the motion module 130 may move a particular portion of the lighting module 110, independent of other portions of the lighting module. For example, the motion module 130 may cause one or more optical lenses associated with the lighting module 110 to rotate and/or move linearly along the x-axis and/or z-axis (e.g., while maintaining a constant separation distance from the LEDs). As another example, clusters of one or more LEDs may move individually, rotating and/or moving linearly relative to the rest of the lighting module 110. The rotation of the cluster may include, as non-limiting examples, rotation about a center point of the lighting module, and/or rotation about a center point of the particular cluster of LEDs.

In some embodiments, the motion module 130 may be configured to expand or contract parts of the lighting module 110. For example, the motion module 130 may cause movement of the submodules 114 relative to the center hub 112. This adjustment may increase or decrease the coverage area of the emitted light over the plant canopy, depending on the growth stage or specific requirements of the plants being cultivated.

In some embodiments, the motion module 130 may be configured to allow linear motion of the lighting module 110 in the y-axis direction, moving the lighting element closer to or further away from the plant. This movement can help to address light intensity and/or overheating concerns.

In summary, the motion module 130 of the lighting system 100 may provide or otherwise facilitate dynamic and precise control over the positioning and distribution of light, which may help to improve, optimize, or otherwise control plant growth and development under various conditions.

### D. A Control System

A control system 140 may be integrated within the apparatus 100.

In embodiments, the control system 140 may manage the operation of the LEDs and the optical lenses disposed within the lighting module 110. The control system 140 may include a microprocessor that processes various inputs (e.g., from one or more sensors, one or more user inputs, one or more timers, and/or the like) to adjust light emission characteristics dynamically. In embodiments, each of the LEDs may be individually addressable, meaning that the control system 140 may adjust the light emission characteristics of each LED individually and independently. This system may allow for the modification of light color (e.g., wavelength/frequency), light intensity, spectral distribution, and focus based on received real-time data.

Each LED in the lighting module 110 may be individually addressable, allowing for precise control over the light spectrum emitted. This individual addressability means that each LED can be programmed to emit light at specific wavelengths independently of other LEDs in the system. The control system 140 may send commands to each LED separately, enabling customized light recipes tailored to different plant growth stages, species requirements, environmental conditions, and/or the like. For example, during vegetative growth, more LEDs may be programmed to emit blue-dominant light (approximately 450-495 nm), while during flowering stages, the individually addressable LEDs may be shifted to emit more red-dominant light (approximately 620-750 nm). This granular control over each LED allows for dynamic adjustment of the overall light spectrum without requiring physical replacement of lighting fixtures when transitioning between growth stages.

The individually addressable nature of the LEDs may also enable the creation of spatial light patterns across the plant canopy. Different zones of the lighting module 110 may be programmed to emit different spectrums or intensities, allowing for customized light distribution that addresses the specific needs of different parts of the plant or different plants within the same growing area. For instance, taller plants may receive higher intensity light from certain individually addressed LEDs, while shorter plants may receive lower intensity light from other LEDs.

Additionally, the individual addressability of each LED may facilitate energy efficiency by allowing precise control over which LEDs are active at any given time. LEDs that are not needed for a particular lighting recipe may be dimmed or turned off completely, reducing power consumption while maintaining optimal growing conditions. The control system 140 may also implement gradual transitions between different lighting states by incrementally adjusting the output of individual LEDs, which may help to prevent plant stress that could result from sudden changes in light conditions.

The individually addressable LEDs may further enable advanced lighting techniques such as photoperiod manipulation, where specific light spectrums are provided at different times of day to simulate natural light cycles or to induce specific growth responses. This capability may be particularly valuable for research applications where precise control over light conditions is essential for studying plant photobiology and developing optimized lighting protocols for various plant species and growth objectives.

For example, the color of light emitted by one or more (e.g., each) of the LEDs may be controlled. As an example, the period of growth between germination and flowering is known as the vegetative phase of plant development. During the vegetative phase, plants are busy carrying out photosynthesis and accumulating resources that will be needed for flowering and reproduction. Different types of plants show different growth habits. Research shows that a higher percentage of blue light for the vegetative cycle is more desirable than it is for the flowering cycle because it signals shorter growth. In the natural environment, in the beginning of the year or growing season, the blue light spectrum is most dominant. Conversely, during peak flowering, the buds of a plant often develop significantly. Essentially, the buds “stretching” their stalks to reach for the sun, as flowering occurs when there is there is less available sunlight, and the available sunlight is a more red dominant light. Accordingly, maintaining a red-dominant spectrum helps to support optimal photosynthesis and development. In still other embodiments, the control system 140 may cause the LEDs to emit light in many colors, running through a series of light spectrums/frequencies. This gives plants light in spectrums that the plant would not naturally receive and would not receive under conventional lighting systems. Combining and rotating through spectrums as described above may help to create a true white spectrum combining all colors. Ultimately, this true white light may be the healthiest white light ever given to a plant from an artificial light.

The control system 140 may be responsible for managing the cooling system 120 to ensure that the LEDs operate within a desired temperature range and/or below a threshold temperature. The control system may determine a temperature range (including at least an upper threshold temperature) based on a preprogrammed maximum allowable temperature, a user-input maximum allowable temperature, and/or a user-input minimum allowable temperature. The control system 140 may adjust the cooling intensity of the cooling system 120 based on received temperature data (e.g., received from sensors placed near the LEDs and/or within the ambient environment) and the determined temperature range of the apparatus.

In some embodiments, the control system 140 may be responsible for operation of the motion module 130. This may involve changing the position of the entire lighting module 110 or specific parts thereof to optimize light distribution over the plant canopy, as described above. Movements may include linear, circular, or canopy wrapping motions, facilitated by components such as servo motors, linear sliding rods, or a cable system.

The control system 140 may provide a user interface that allows users to input specific growth requirements or select predefined lighting programs. This interface may display relevant information such as current light settings, temperature conditions, and system status. It may also offer simulation tools to visualize the effects of different lighting setups before they are implemented. In some embodiments, the predefined lighting programs may be based on one or more growth goals, a plant species and/or subspecies, a particular geolocation (e.g., simulating natural light patterns at a particular location), and/or various other factors that may be helpful to a grower.

In an embodiment, one or more components of control system 140 may use an artificial intelligence, such as a machine learning engine 142. In particular, the machine learning engine 142 may be used to classify plant health based on received images or sensor data. Machine learning includes various techniques in the field of artificial intelligence that deal with computer-implemented, user-independent processes for solving problems that have variable inputs.

In some embodiments, the machine learning engine 142 trains a machine learning model 144 to perform one or more operations. Training a machine learning model 144 uses training data to generate a function that, given one or more inputs to the machine learning model 144, computes a corresponding output. The output may correspond to a prediction based on prior machine learning. In an embodiment, the output includes a label, classification, and/or categorization assigned to the provided input(s). The machine learning model 144 corresponds to a learned model for performing the desired operation(s) (e.g., labeling, classifying, and/or categorizing inputs). The module 140 may use multiple machine learning engines 142 and/or multiple machine learning models 144 for different purposes (e.g., tracking different species of plants, tracking different aspects of plant health, etc.).

In an embodiment, the machine learning engine 142 may use supervised learning, semi-supervised learning, unsupervised learning, reinforcement learning, and/or another training method or combination thereof. In supervised learning, labeled training data includes input/output pairs in which each input is labeled with a desired output (e.g., a label, classification, and/or categorization), also referred to as a supervisory signal. In semi-supervised learning, some inputs are associated with supervisory signals and other inputs are not associated with supervisory signals. In unsupervised learning, the training data does not include supervisory signals. Reinforcement learning uses a feedback system in which the machine learning engine 142 receives positive and/or negative reinforcement in the process of attempting to solve a particular problem (e.g., to optimize performance in a particular scenario, according to one or more predefined performance criteria). One example of a network for use in reinforcement learning is a recurrent neural network, which may include a backpropagation or feedback pathway to correct or improve the response of the network.

In an embodiment, a machine learning engine 142 may use many different techniques to label, classify, and/or categorize inputs. A machine learning engine 142 may transform inputs (e.g., the received plant images and/or the received sensor data) into feature vectors that describe one or more properties (“features”) of the inputs. The machine learning engine 142 may label, classify, and/or categorize the inputs based on the feature vectors. Alternatively or additionally, a machine learning engine 142 may use clustering (also referred to as cluster analysis) to identify commonalities in the inputs. The machine learning engine 142 may group (i.e., cluster) the inputs based on those commonalities. The machine learning engine 142 may use hierarchical clustering, k-means clustering, and/or another clustering method or combination thereof. For example, the machine learning engine 142 may receive, as inputs, one or more extracted features of an image of a plant, and may identify one or more plant health classifications based on commonalities between the received extracted features and features associated with images corresponding to plants having a variety of health statuses. In an embodiment, a machine learning engine 142 includes an artificial neural network. An artificial neural network includes multiple nodes (also referred to as artificial neurons) and edges between nodes. Edges may be associated with corresponding weights that represent the strengths of connections between nodes, which the machine learning engine 142 adjusts as machine learning proceeds. Alternatively or additionally, a machine learning engine 142 may include a support vector machine. A support vector machine represents inputs as vectors. The machine learning engine 142 may label, classify, and/or categorizes inputs based on the vectors. Alternatively or additionally, the machine learning engine 142 may use a naïve Bayes classifier to label, classify, and/or categorize inputs. Alternatively or additionally, given a particular input, a machine learning model may apply a decision tree to predict an output for the given input. Alternatively or additionally, a machine learning engine 142 may apply fuzzy logic in situations where labeling, classifying, and/or categorizing an input among a fixed set of mutually exclusive options is impossible or impractical. The aforementioned machine learning model 144 and techniques are discussed for exemplary purposes only and should not be construed as limiting one or more embodiments.

In an embodiment, as a machine learning engine 142 applies different inputs to a machine learning model 144, the corresponding outputs are not always accurate. As an example, the machine learning engine 142 may use supervised learning to train a machine learning model 144. After training the machine learning model 144, if a subsequent input is identical to an input that was included in labeled training data and the output is identical to the supervisory signal in the training data, then output is certain to be accurate. If an input is different from inputs that were included in labeled training data, then the machine learning engine 142 may generate a corresponding output that is inaccurate or of uncertain accuracy. In addition to producing a particular output for a given input, the machine learning engine 142 may be configured to produce an indicator representing a confidence (or lack thereof) in the accuracy of the output. A confidence indicator may include a numeric score, a Boolean value, and/or any other kind of indicator that corresponds to a confidence (or lack thereof) in the accuracy of the output.

In embodiments, the determined output may comprise an indication of the health of the plant being photographed. For example, the images may show discoloration, morphology or growth irregularities, pests, etc. The output may be used to generate a notification for transmission to a grower. For example, the notification may include the indication of the plant health. In some embodiments, the notification may further include an indication of additional steps that would improve plant health. As a non-limiting example, the notification may include an indication of area of irregular plant morphology, and a recommendation to prune the irregular area. As another non-limiting example, the notification may comprise an indication of one or more pests found on the plant, along with a list of one or more treatments effective to remove the pests. The notification may be delivered electronically. For example, the notification may be delivered as an email, a text message, an in-app notification, or any other method of electronically delivering the notification.

The control system 140 may be designed to operate in various modes, including an emergency lighting mode that activates during power outages to maintain essential light exposure using a battery backup system. This mode may include a white light inspection feature to assist in the analysis of plant health attributes such as leaf pests, nutrient deficiencies, and flower colors.

Overall, the control system 140 may serve as a central hub for coordinating the functions of the lighting apparatus, ensuring that all components work together to provide an optimal growth environment for plants.

### E. One or More Sensors

In some embodiments, the apparatus 100 may optionally include one or more sensors 150 used for sensing various properties of the apparatus itself, the plant disposed within the apparatus, and/or the ambient area surrounding the apparatus. The sensors may be configured to monitor various parameters, such as (but not limited to) temperature, humidity, light characteristics, soil characteristics (e.g., moisture, pH, etc.), proximity of the plant canopy, and any other characteristics of the apparatus, plant, and/or ambient environment that may be useful in improving one or more plant growth characteristics. These sensors 150 may provide valuable data to the control system 140, which may then adjust the operation of the apparatus accordingly to optimize plant growth conditions. For instance, temperature sensors (e.g., thermometers, thermocouples, etc.) may detect the heat levels within the apparatus and surrounding environment, enabling the cooling system to activate and maintain the LEDs at the desired operating temperature.

As one particular, example, the sensors 150 may include a photosensor installed near a base of the plant. The photosensor may be used to measure an amount of light penetrating the plant canopy to reach the base of the plant. This information may then be used to adjust a light intensity, focusing distance, and/or other characteristic of the light emitted by the lighting module 110.

In some embodiments, a photosensor may be used to measure the colors and intensities of light received ambiently at the plant (e.g., alone, or in conjunction with the light received from the lighting module 110). The sensors may measure at a single location or at multiple locations around the plant (e.g., at the canopy and also at the base). The control module 140 may receive this information from the sensors 150 and, in response, may adjust the light produced by the lighting module 110 to affect a particular “light diet” for the plant being grown, such that the ratio of each wavelength of light is controlled.

In some embodiments, the sensors 150 may include a photosensor used to track wavelengths of light emitted by the lighting element. The sensors 150 may further include a camera used to view at least a portion of the plant. The control module 140 may receive, as inputs, the wavelength of the light emitted by the lighting element at a particular time and an image of the plant at that same time. The control module 140 may track the response of the plant to various wavelengths of light in the photosynthetically active spectrum to determine wavelengths that elicit positive and/or negative responses from the plant. Wavelengths that receive positive responses may be increased in the plant “light diet”, while wavelengths that receive negative responses may be decreased.

Proximity sensors may be employed to determine a distance between the light sources and the plant canopy. This information may be utilized by the control system 140 to adjust the height and/or angle of the light sources, helping to ensure optimal light distribution across the plant canopy. Infrared sensors may be used to monitor the health and growth stages of the plants by detecting changes in the infrared signature of the foliage, which may indicate various physiological states or stress levels.

The apparatus 100 may include one or more sensors (e.g., photosensors) for detecting ambient light conditions. These sensors may help in adjusting the intensity and spectrum of the light emitted by the apparatus 100 to complement the natural light, thereby providing a more controlled and effective growth environment for the plants.

Overall, the integration of the one or more sensors 150 into the apparatus allows for a dynamic and responsive system that can adapt to both the needs of the plants and the environmental conditions, promoting efficient and robust plant growth.

### F. Peripheral Devices

In some embodiments, the apparatus 100 may optionally include one or more additional peripherals. The peripherals may be selectively attachable/detachable and/or selectively mountable on the apparatus 100 via magnets, mounts, and/or the like: In embodiments, the peripherals may include, as non-limiting examples, fans, additional sensors, hooks for retaining strings/cables/wires to help hold flowers/buds upright, etc. There are many different peripherals that may prove useful in the use of the apparatus.

### III. Computing Device

Embodiments of the present disclosure provide a hardware and software platform operative as a distributed system of modules and computing elements.

Apparatus 100 may be embodied as, for example, but not be limited to, a website, a web application, a desktop application, a backend application, and a mobile application compatible with a computing device 700. The computing device 700 may comprise, but not be limited to, the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exascale supercomputer, a mainframe, or a quantum computer;

A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack-mounted, a workstation, an industrial device, a raspberry pi, a desktop, or an embedded device;

Embodiments of the present disclosure may comprise a system having a central processing unit (CPU) 720, a bus 730, a memory unit 740, a power supply unit (PSU) 750, and one or more Input/Output (I/O) units. The CPU 720 coupled to the memory unit 740 and the plurality of I/O units 760 via the bus 730, all of which are powered by the PSU 750. It should be understood that, in some embodiments, each disclosed unit may actually be a plurality of such units for redundancy, high availability, and/or performance purposes. The combination of the presently disclosed units is configured to perform the stages of any method disclosed herein.

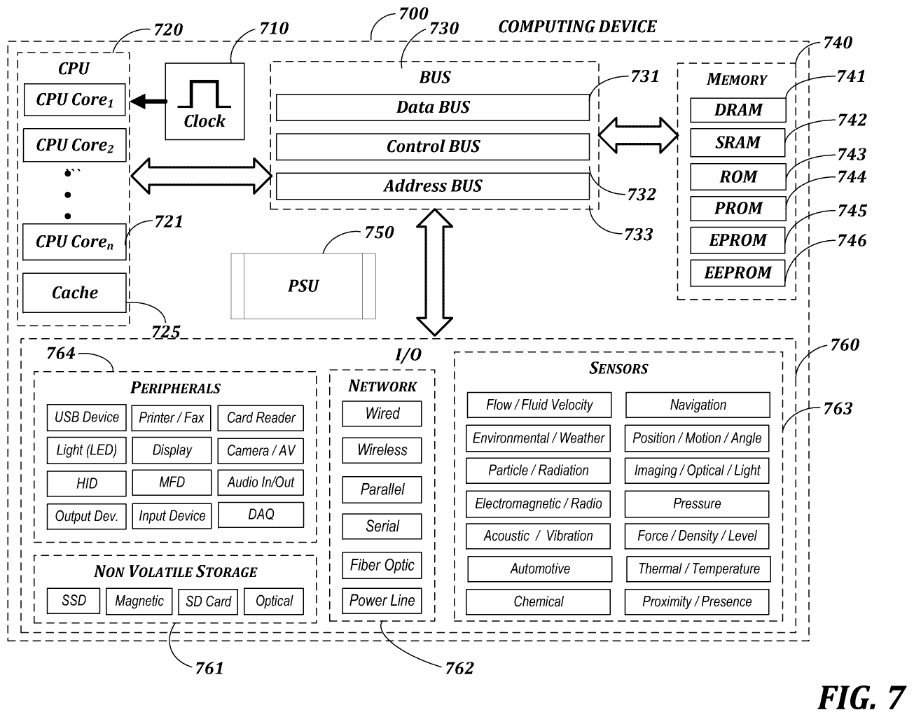

FIG. 7 is a block diagram of a system including computing device 700. Consistent with an embodiment of the disclosure, the aforementioned CPU 720, the bus 730, the memory unit 740, a PSU 750, and the plurality of I/O units 760 may be implemented in a computing device, such as computing device 700 of FIG. 7. Any suitable combination of hardware, software, or firmware may be used to implement the aforementioned units. For example, the CPU 720, the bus 730, and the memory unit 740 may be implemented with computing device 700 or any of other computing devices 700, in combination with computing device 700. The aforementioned system, device, and components are examples and other systems, devices, and components may comprise the aforementioned CPU 720, the bus 730, and the memory unit 740, consistent with embodiments of the disclosure.

At least one computing device 700 may be embodied as any of the computing elements illustrated in all of the attached figures. A computing device 700 does not need to be electronic, nor even have a CPU 720, nor bus 730, nor memory unit 740. The definition of the computing device 700 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 700, especially if the processing is purposeful.

With reference to FIG. 7, a system consistent with an embodiment of the disclosure may include a computing device, such as computing device 700. In some configurations, the computing device 700 may include at least one clock module 710, at least one CPU 720, at least one bus 730, and at least one memory unit 740, at least one PSU 750, and at least one I/O 760 module, wherein I/O module may be comprised of, but not limited to a non-volatile storage sub-module 761, a communication sub-module 762, a sensors sub-module 763, and a peripherals sub-module 764.

In a system consistent with an embodiment of the disclosure, the computing device 700 may include the clock module 710, known to a person having ordinary skill in the art as a clock generator, which produces clock signals. Clock signals may oscillate between a high state and a low state at a controllable rate and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 720, the central component of modern computers, which relies on a clock signal. The clock 710 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 700 may use a “clock multiplier” which multiplies a lower frequency external clock to the appropriate clock rate of the CPU 720. This allows the CPU 720 to operate at a much higher frequency than the rest of the computing device 700, which affords performance gains in situations where the CPU 720 does not need to wait on an external factor (like memory 740 or input/output 760). Some embodiments of the clock 710 may include dynamic frequency change, where the time between clock edges can vary widely from one edge to the next and back again.

In a system consistent with an embodiment of the disclosure, the computing device 700 may include the CPU 720 comprising at least one CPU Core 721. In other embodiments, the CPU 720 may include a plurality of identical CPU cores 721, such as, but not limited to, homogeneous multi-core systems. It is also possible for the plurality of CPU cores 721 to comprise different CPU cores 721, such as, but not limited to, heterogeneous multi-core systems, big.LITTLE systems and some AMD accelerated processing units (APU). The CPU 720 reads and executes program instructions which may be used across many application domains, for example, but not limited to, general purpose computing, embedded computing, network computing, digital signal processing (DSP), and graphics processing (GPU). The CPU 720 may run multiple instructions on separate CPU cores 721 simultaneously. The CPU 720 may be integrated into at least one of a single integrated circuit die, and multiple dies in a single chip package. The single integrated circuit die and/or the multiple dies in a single chip package may contain a plurality of other elements of the computing device 700, for example, but not limited to, the clock 710, the bus 730, the memory 740, and I/O 760.

The CPU 720 may contain cache 722 such as but not limited to a level 1 cache, a level 2 cache, a level 3 cache, or combinations thereof. The cache 722 may or may not be shared amongst a plurality of CPU cores 721. The cache 722 sharing may comprise at least one of message passing and inter-core communication methods used for the at least one CPU Core 721 to communicate with the cache 722. The inter-core communication methods may comprise, but not be limited to, bus, ring, two-dimensional mesh, and crossbar. The aforementioned CPU 720 may employ symmetric multiprocessing (SMP) design.

The one or more CPU cores 721 may comprise soft microprocessor cores on a single field programmable gate array (FPGA), such as semiconductor intellectual property cores (IP Core). The architectures of the one or more CPU cores 721 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 721, for example, but not limited to Instruction-level parallelism (ILP) such as, but not limited to, superscalar pipelining, and Thread-level parallelism (TLP).

Consistent with the embodiments of the present disclosure, the aforementioned computing device 700 may employ a communication system that transfers data between components inside the computing device 700, and/or the plurality of computing devices 700. The aforementioned communication system will be known to a person having ordinary skill in the art as a bus 730. The bus 730 may embody internal and/or external hardware and software components, for example, but not limited to a wire, an optical fiber, various communication protocols, and/or any physical arrangement that provides the same logical function as a parallel electrical bus. The bus 730 may comprise at least one of a parallel bus, wherein the parallel bus carries data words in parallel on multiple wires; and a serial bus, wherein the serial bus carries data in bit-wise serial form. The bus 730 may embody a plurality of topologies, for example, but not limited to, a multidrop/electrical parallel topology, a daisy chain topology, and connected by switched hubs, such as a USB bus. The bus 730 may comprise a plurality of embodiments, for example, but not limited to:
Internal data bus (data bus) 731/Memory bus
Control bus 732
Address bus 733
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper {Cu} Link]), Express Card, AdvancedTCA, AMC, Universal IO, Thunderbolt/Mini DisplayPort, Mobile PCle (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 700 may employ hardware integrated circuits that store information for immediate use in the computing device 700, known to persons having ordinary skill in the art as primary storage or memory 740. The memory 740 operates at high speed, distinguishing it from the non-volatile storage sub-module 761, which may be referred to as secondary or tertiary storage, which provides relatively slower-access to information but offers higher storage capacity. The data contained in memory 740, may be transferred to secondary storage via techniques such as, but not limited to, virtual memory and swap. The memory 740 may be associated with addressable semiconductor memory, such as integrated circuits consisting of silicon-based transistors, that may be used as primary storage or for other purposes in the computing device 700. The memory 740 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 741, Static Random-Access Memory (SRAM) 742, CPU Cache memory 725, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 743, Programmable ROM (PROM) 744, Erasable PROM (EPROM) 745, Electrically Erasable PROM (EEPROM) 746 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 700 may employ a communication system between an information processing system, such as the computing device 700, and the outside world, for example, but not limited to, human, environment, and another computing device 700. The aforementioned communication system may be known to a person having ordinary skill in the art as an Input/Output (I/O) module 760. The I/O module 760 regulates a plurality of inputs and outputs with regard to the computing device 700, wherein the inputs are a plurality of signals and data received by the computing device 700, and the outputs are the plurality of signals and data sent from the computing device 700. The I/O module 760 interfaces with a plurality of hardware, such as, but not limited to, non-volatile storage 761, communication devices 762, sensors 763, and peripherals 764. The plurality of hardware is used by at least one of, but not limited to, humans, the environment, and another computing device 700 to communicate with the present computing device 700. The I/O module 760 may comprise a plurality of forms, for example, but not limited to channel I/O, port mapped I/O, asynchronous I/O, and Direct Memory Access (DMA).

Consistent with the embodiments of the present disclosure, the aforementioned computing device 700 may employ a non-volatile storage sub-module 761, which may be referred to by a person having ordinary skill in the art as one of secondary storage, external memory, tertiary storage, off-line storage, and auxiliary storage. The non-volatile storage sub-module 761 may not be accessed directly by the CPU 720 without using an intermediate area in the memory 740. The non-volatile storage sub-module 761 may not lose data when power is removed and may be orders of magnitude less costly than storage used in memory 740. Further, the non-volatile storage sub-module 761 may have a slower speed and higher latency than in other areas of the computing device 700. The non-volatile storage sub-module 761 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (761) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 700 may employ a communication sub-module 762 as a subset of the I/O module 760, which may be referred to by a person having ordinary skill in the art as at least one of, but not limited to, a computer network, a data network, and a network. The network may allow computing devices 700 to exchange data using connections, which may also be known to a person having ordinary skill in the art as data links, which may include data links between network nodes. The nodes may comprise networked computer devices 700 that may be configured to originate, route, and/or terminate data. The nodes may be identified by network addresses and may include a plurality of hosts consistent with the embodiments of a computing device 700. Examples of computing devices that may include a communication sub-module 762 include, but are not limited to, personal computers, phones, servers, drones, and networking devices such as, but not limited to, hubs, switches, routers, modems, and firewalls.

Two nodes can be considered networked together when one computing device 700 can exchange information with the other computing device 700, regardless of any direct connection between the two computing devices 700. The communication sub-module 762 supports a plurality of applications and services, such as, but not limited to World Wide Web (WWW), digital video and audio, shared use of application and storage computing devices 700, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPV6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 762 may comprise a plurality of size, topology, traffic control mechanisms and organizational intent policies. The communication sub-module 762 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 700 may employ a sensors sub-module 763 as a subset of the I/O 760. The sensors sub-module 763 comprises at least one of the device, module, or subsystem whose purpose is to detect events or changes in its environment and send the information to the computing device 700. Sensors may be sensitive to the property they are configured to measure, may not be sensitive to any property not measured but be encountered in its application, and may not significantly influence the measured property. The sensors sub-module 763 may comprise a plurality of digital devices and analog devices, wherein if an analog device is used, an Analog to Digital (A-to-D) converter must be employed to interface the said device with the computing device 700. The sensors may be subject to a plurality of deviations that limit sensor accuracy. The sensors sub-module 763 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 700 may employ a peripherals sub-module 764 as a subset of the I/O 760. The peripheral sub-module 764 comprises ancillary devices used to put information into and get information out of the computing device 700. There are 3 categories of devices comprising the peripheral sub-module 764, which exist based on their relationship with the computing device 700, input devices, output devices, and input/output devices. Input devices send at least one of data and instructions to the computing device 700. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 700. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 764:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 700. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound.
   Audio input devices allow a user to send audio signals to the computing device 700 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.

Data AcQuisition (DAQ) devices convert at least one of analog signals and physical parameters to digital values for processing by the computing device 700. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 762), data storage devices (non-volatile storage 761), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

Claims:

1. An apparatus for plant growth illumination, comprising:
a plurality of light emitting diodes (LEDs) configured to emit light in a spectrum between 300 nm and 800 nm;
a plurality of optical lenses individually associated with respective ones of the plurality of LEDs, wherein each optical lens is adjustable relative to its associated LED to modify a focus of the emitted light; and
a cooling system integrated with the plurality of LEDs, the cooling system selected from the group consisting of: a liquid cooling system, and a Peltier cooling system, wherein the apparatus is configured to maintain an operating temperature of the LEDs at a predetermined value.

2. The apparatus of claim 1, wherein each LED is individually addressable to emit light at a specific wavelength within the spectrum based on a growth stage of a plant.

3. The apparatus of claim 2, wherein the predetermined value of the operating temperature is approximately 80 degrees Fahrenheit.

4. The apparatus of claim 1, further comprising a control system configured to adjust a distance between each optical lens and its associated LED based on sensor input indicating a distance from the LED to a plant canopy.

5. The apparatus of claim 4, wherein the control system is further configured to adjust an emitted light intensity and footprint by moving the optical lens closer to or further from its associated LED.

6. The apparatus of claim 5, wherein the control system includes a microprocessor for controlling each LED and optical lens independently based on programmable light spectrum requirements of a plant.

7. The apparatus of claim 6, further comprising a user interface configured to allow a user to program the light spectrum requirements for different growth stages of a plant.

8. The apparatus of claim 1, further comprising a structural mechanism configured to adjust a position of the apparatus or portions thereof relative to a plant canopy, the structural mechanism selected from the group consisting of: servo motors, linear sliding rods, and a cable system.

9. The apparatus of claim 8, wherein the structural mechanism is configured to perform movements selected from the group consisting of: linear motion, circular motion, and canopy wrapping motion.

10. The apparatus of claim 9, wherein the canopy wrapping motion involves expanding or contracting parts of the apparatus to increase or decrease a coverage area of the emitted light over the plant canopy.

11. The apparatus of claim 1, further comprising at least one sensor selected from the group consisting of: one or more proximity sensors, one or more infrared sensors, one or more photosensors, and one or more temperature sensors, wherein the at least one sensor provides input to a control system for dynamically adjusting the light emission based on environmental conditions and plant growth stages.

12. The apparatus of claim 11, wherein the apparatus further comprises an emergency lighting mode, including a battery backup system configured to maintain plant photoreactivity during power outages.

13. The apparatus of claim 12, wherein the emergency lighting mode includes a white light inspection feature for analyzing plant health attributes selected from the group consisting of: leaf pests, nutrient deficiencies, and flower colors.

14. An apparatus for providing spatial light distribution over a plant canopy, comprising:
a plurality of light sources configured to emit light at varying spectrums;
a support structure maintaining the plurality of light sources;
a motorized adjustment mechanism coupled with the support structure, configured to alter a position of the plurality of light sources relative to the plant canopy; and
wherein the motorized adjustment mechanism is configured to move the plurality of light sources in at least one of a vertical and horizontal direction relative to the plant canopy.

15. The apparatus of claim 14, wherein the motorized adjustment mechanism includes a series of weights and balances, spools of wire, or servo motors to facilitate movement of the plurality of light sources.

16. The apparatus of claim 15, wherein the motorized adjustment mechanism further comprises linear sliding rods integrated into the support structure to enable linear movement of the plurality of light sources.

17. The apparatus of claim 14, further comprising proximity sensors and infrared sensors integrated with the motorized adjustment mechanism, configured to detect a distance between the light sources and the plant canopy and control the motorized adjustment mechanism based on the detected distance.

18. The apparatus of claim 17, wherein the proximity sensors and infrared sensors facilitate automatic adjustment of the light sources to optimize light distribution based on plant growth stage or environmental conditions.

19. An apparatus for adjustable spatial light distribution over a plant canopy, comprising:
a lighting assembly including a plurality of light emitting diodes (LEDs);
a controllable movement system operatively connected to the lighting assembly, configured to adjust a position of the lighting assembly over the plant canopy; and
wherein the controllable movement system is capable of expanding or contracting the lighting assembly to vary the distribution of light over the plant canopy.

20. The apparatus of claim 19, wherein the controllable movement system includes an expandable mechanical rail system that adjusts spacing between components of the lighting assembly.
